(19) United States
(12) Patent Application Publication
(10) Pub. No.: US 2023/0410374 A1
(43) Pub. Date: Dec. 21, 2023

(54) METHOD AND APPARATUS FOR MESH COMPRESSION USING POINT CLOUD CODING

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/242,391

(22) Filed: Sep. 5, 2023

Related U.S. Application Data
(63) Continuation of application No. PCT/KR2022/003191, filed on Mar. 7, 2022.

(30) Foreign Application Priority Data
Mar. 8, 2021 (KR) 10-2021-0030286
Mar. 4, 2022 (KR) 10-2022-0027875

(51) Int. Cl. G06T 9/00; G06T 17/20; G06T 15/04

(52) U.S. Cl. CPC G06T 9/001; G06T 17/20; G06T 15/04

(57) ABSTRACT

A mesh compression method and an apparatus utilize point cloud compression. The mesh compression method and apparatus transform the three-dimensional mesh into a point cloud and then compress/reconstruct the three-dimensional mesh using a point cloud compression method to improve the coding efficiency of a three-dimensional mesh.

### CROSS-REFERENCE TO RELATED APPLICATIONS

This application is a continuation of International Application No. PCT/KR2022/003191 filed on Mar. 7, 2022, which claims priority to Korean Patent Application No. 10-2021-0030286 filed on Mar. 8, 2021 and Korean Patent Application No. 10-2022-0027875 filed on Mar. 4, 2022, the entire disclosures of which are incorporated herein by reference.

### TECHNICAL FIELD

The present disclosure relates to a mesh compression method and an apparatus using point cloud compression.

### BACKGROUND

The statements in this section merely provide background information related to the present disclosure and do not necessarily constitute prior art.

Three-dimensional mesh information is a type of data that is widely used in various fields such as three-dimensional modeling, navigation, and gaming. Typically, mesh data includes three-dimensional coordinates of vertices expressed in ASCII code, two-dimensional coordinates of texture vertices, three-dimensional normal vectors of vertices, and edge information expressing the connectivity of a polygon consisting of multiple vertices. Additionally, the mesh data may include a texture map compressed using a separate image codec such as PNG, JPEG, or JPEG2000. Here, the texture vertices represent vertices orthogonally projected into a two-dimensional uv domain Thus, a texture map represents a packed image of the attribute values of the vertices projected into the uv domain. In this case, various projective spaces such as spherical, cylindrical, and the like can be used as the uv domain. Further, the attribute information defining the attribute values of the vertices may include color information, texture information, transparency, and the like of the vertices.

The examples of FIGS. 1A, 1B, and 1C illustrate data contained in a three-dimensional mesh. In the example of FIG. 1A, the mesh represents a tetrahedral object in three-dimensional space, wherein the mesh includes a total of four vertices. In addition, the edge information connecting each vertex of the mesh to represent the tetrahedron is represented by a line. The examples of FIGS. 1B and 1C illustrate commonly used schemes in representing the mesh illustrated in FIG. 1A. The example of FIG. 1B illustrates texture vertices of a three-dimensional mesh represented in two-dimensional uv space and edge information representing connectivity between the texture vertices. The example of FIG. 1C shows the ASCII code expressions of the location of vertices, the location of texture vertices, and the connectivity between vertices and texture vertices.

Three-dimensional meshes are increasingly being used in a wider range of applications, and are expected to be popularized over autonomous driving, mobile, and other fields hereafter. Therefore, methods and apparatus need to be provided for efficiently compressing meshes in terms of transmission and storage.

### SUMMARY

The present disclosure in some embodiments seeks to provide an encoding/decoding apparatus and a method for transforming the three-dimensional mesh into a point cloud and then compressing/reconstructing the three-dimensional mesh using a point cloud compression method.

At least one aspect of the present disclosure provides a decoding method performed by a mesh decoding apparatus for decoding a mesh that is three-dimensional. The decoding method includes separating a bitstream into a first bitstream and a second bitstream. The first bitstream is obtained by encoding a point cloud representative of the mesh and the second bitstream is obtained by encoding edge data of the mesh. The decoding method also includes decoding the point cloud from the first bitstream. The decoding method also includes decoding the edge data from the second bitstream. The decoding method also includes synthesizing the mesh by generating planes of polygons using the edge data and by generating a texture of the planes using attribute values of the point cloud, which are closest to the planes.

Another aspect of the present disclosure provides a mesh decoding apparatus for decoding a mesh that is three-dimensional. The apparatus includes a bitstream splitter configured to separate a bitstream into a first bitstream and a second bitstream. The first bitstream is obtained by encoding a point cloud representative of the mesh and the second bitstream is obtained by encoding edge data of the mesh. The apparatus also includes a point cloud decoder configured to decode the point cloud from the first bitstream. The apparatus also includes an edge decoder configured to decode the edge data from the second bitstream. The apparatus also includes a mesh synthesizer configured to synthesize the mesh by generating planes of polygons using the edge data and by generating a texture of the planes using attribute values of the point cloud, which are closest to the planes.

Yet another aspect of the present disclosure provides a encoding method performed by a mesh encoding apparatus for encoding a mesh that is three-dimensional. The encoding method includes obtaining the mesh and extracting edge data of polygons from the mesh. The encoding method also includes extracting vertices from the mesh and generating a texture map, and then transforming the mesh into a point cloud by using the vertices, the edge data, and the texture map. The encoding method also includes generating a first bitstream by encoding the point cloud and generating a second bitstream by encoding the edge data. The encoding method also includes synthesizing the first bitstream and the second bitstream to generate a bitstream.

As described above, the present disclosure provides an encoding/decoding apparatus and a method for transforming the three-dimensional mesh into a point cloud. The encoding/decoding apparatus and method compress/reconstruct the three-dimensional mesh using the point cloud compression method. The coding efficiency of the three-dimensional mesh is thereby improved.

### BRIEF DESCRIPTION OF THE DRAWINGS

FIGS. 1A-1C are diagrams illustrating data contained in a three-dimensional mesh.

FIGS. 2A and 2B are block diagrams conceptually representing a mesh encoding apparatus and a mesh decoding apparatus.

FIGS. 3A and 3B are block diagrams conceptually representing a mesh encoding apparatus and a mesh decoding apparatus according to at least one embodiment of the present disclosure.

FIG. 4 is a block diagram conceptually illustrating a point cloud transformer according to at least one embodiment of the present disclosure.

FIG. 5 is a diagram illustrating geometric information generation of a point cloud according to at least one embodiment of the present disclosure.

FIG. 6 is a block diagram conceptually illustrating a point cloud encoder according to at least one embodiment of the present disclosure.

FIG. 7 is a block diagram conceptually illustrating a point cloud decoder according to at least one embodiment of the present disclosure.

FIGS. 8A and 8B are block diagrams conceptually illustrating a mesh encoding apparatus and a mesh decoding apparatus according to other embodiments of the present disclosure.

FIG. 9 is a block diagram conceptually illustrating a point cloud encoder according to another embodiment of the present disclosure.

FIG. 10 is a block diagram conceptually illustrating a point cloud decoder according to another embodiment of the present disclosure.

FIG. 11 is a block diagram conceptually illustrating a mesh encoding apparatus utilizing reconstructed vertex information according to yet another embodiment of the present disclosure.

FIGS. 12A and 12B are flowcharts of a mesh encoding method according to at least one embodiment of the present disclosure.

FIG. 13 is a flowchart of a mesh decoding method according to at least one embodiment of the present disclosure.

FIGS. 14A and 14B are flowcharts of a mesh encoding method according to another embodiment of the present disclosure.

FIG. 15 is a flowchart of a mesh decoding method according to another embodiment of the present disclosure.

FIG. 16 is a flowchart of a mesh encoding method according to yet another embodiment of the present disclosure.

FIG. 17 is a flowchart of a mesh decoding method according to yet another embodiment of the present disclosure.

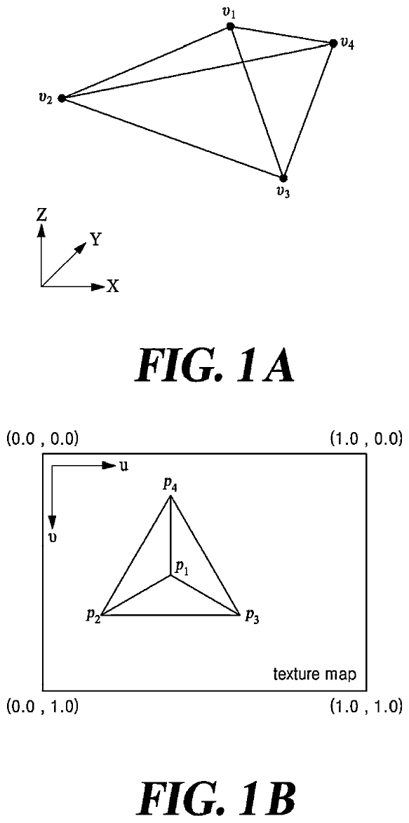

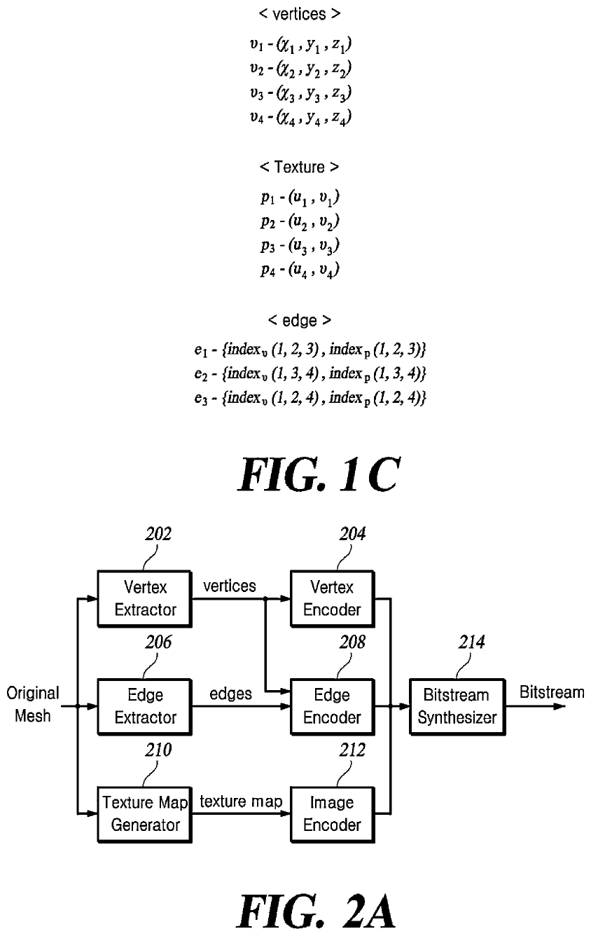

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions, where considered to obscure the subject of the present disclosure, may have been omitted for the purpose of clarity and for brevity.

The present embodiments relate to a mesh compression method and apparatus utilizing point cloud compression. More specifically, to improve the coding efficiency of a three-dimensional mesh, the present disclosure provides a mesh encoding/decoding apparatus and a method that transform the three-dimensional mesh into a point cloud, and then compress/reconstruct the three-dimensional mesh using a point cloud compression method.

In the following description, mesh information and mesh data are used interchangeably. Additionally, vertex information and vertex data, edge information and edge data, texture map information and texture map data, and patch information and patch data may be utilized interchangeably.

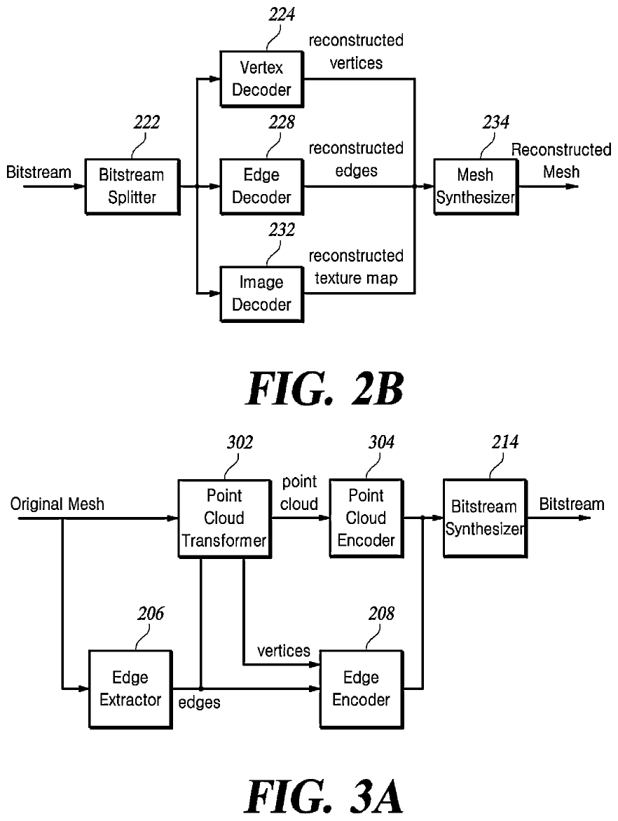

Described first, with reference to FIGS. 2A and 2B, are apparatuses for encoding and decoding a mesh by partitioning the mesh into vertex information, texture map information, and edge information.

FIGS. 2A and 2B are block diagrams conceptually representing a mesh encoding apparatus and a mesh decoding apparatus.

As illustrated in FIG. 2A, the mesh encoding apparatus may partition a mesh into vertex information, texture map information, and edge information, and then encode them to generate a bitstream. The mesh encoding apparatus may store the generated bitstream or transmit it to the mesh decoding apparatus. The mesh encoding apparatus includes all or part of a vertex extractor 202, a vertex encoder 204, an edge extractor 206, an edge encoder 208, a texture map generator 210, an image encoder 212, and a bitstream synthesizer 214.

The vertex extractor 202 extracts, from the original mesh information, such an ASCII expression of data as coordinate values of vertices, normal vectors of vertices, and coordinate values of texture vertices. The extracted vertex data may be transferred to the vertex encoder 204 and the edge encoder 208. The vertex encoder 204 may compress the transferred vertex data to generate a bitstream. To compress the vertex data, any conventional lossless data compression method may be utilized. For example, the vertex encoder 204 may use an open-source program such as gzip to compress the vertex data into a smaller amount of data than the original data to generate the bitstream. In another embodiment, the vertex encoder 204 may generate the bitstream by packing the vertex data on a per byte basis without compression. The generated bitstream may be transferred to the bitstream synthesizer 214.

The edge extractor 206 may extract the edge data of polygons from the original mesh information and represent it as an ASCII expression of data. The extracted edge data may be transferred to the edge encoder 208. The edge encoder 208 may compress the edge data to generate a bitstream. In addition, the edge encoder 208 may utilize the data of the vertices generated by the vertex extractor 202 when encoding the edge data. The edge encoder 208 may utilize common data compression methods to encode the edge data. Alternatively, the edge encoder 208 may pack the edge data uncompressed on a per byte basis to generate a bitstream.

In another embodiment, the edge encoder 208 may generate the bitstream by using a common lossless compression method. For example, an edgebreaker, a common polygonal connectivity compression method, may be utilized. In other words, the edge encoder 208 may use the edgebreaker to represent the connectivity as a plurality of symbols and then encode those symbols to generate a bitstream. Alternatively, the edge encoder 208 may selectively apply a common data compression method to some of the edge data and the edgebreaker to the remaining edge data to generate the bitstream. The generated bitstream may be transferred to the bitstream synthesizer 214.

The texture map generator 210 may generate a two-dimensional texture map by orthogonally projecting the textures of the planes of the three-dimensional objects in the original mesh into the two-dimensional uv domain. Alternatively, if the texture information of the original mesh is in the form of a bitstream generated by image compression such as Joint Photographic coding Experts Group (JPEG), JPEG2000, Portable Network Graphics (PNG), High Efficiency Image File Format (HEIF), or the like, the texture map generator 210 may decode the compressed image to generate a reconstructed texture map. The generated texture map may be transferred to the image encoder 212. The image encoder 212 may compress the inputted texture map to generate a bitstream. In this case, the image encoder 212 may utilize a variety of techniques for image compression, such as JPEG, JPEG2000, PNG, HEIF, and the like. Alternatively, video compression techniques such as H.264/Advanced Video Coding (AVC), H.265/High Efficiency Video Coding (HEVC), H.266/Versatile Video Coding (VVC), and the like may be used. The generated bitstream may be transferred to the bitstream synthesizer 214.

The bitstream synthesizer 214 may synthesize all of the inputted bitstreams to generate a single bitstream. The mesh encoding apparatus may transfer the generated bitstream to the mesh decoding apparatus.

Meanwhile, as illustrated in FIG. 2B, the mesh decoding apparatus decodes the delivered bitstream to reconstruct vertex information, texture map information, and edge information. The mesh decoding apparatus may synthesize the reconstructed data to reconstruct the original mesh. The mesh decoding apparatus may include all or part of a bitstream splitter 222, a vertex decoder 224, an edge decoder 228, an image decoder 232, and a mesh synthesizer 234.

The bitstream splitter 222 may separate the transferred bitstream into a vertex-related bitstream, edge-related bitstream, and a texture map-related bitstream, which may be transferred to the vertex decoder 224, edge decoder 228, and image decoder 232, respectively.

The vertex decoder 224 may reconstruct the vertex data by decoding the transferred vertex-related bitstream. As described above, the vertex data may include coordinate values of vertices, normal vectors of vertices, coordinate values of texture vertices, and the like. The reconstructed vertex data may be transferred to the mesh synthesizer 234.

The edge decoder 228 reconstructs the edge data by decoding the transferred edge-related bitstream. As the edge data reconstruction method, the present disclosure may use a decoding method corresponding to the encoding method used by the edge encoder 208 in the mesh encoding apparatus. The reconstructed edge data may be transferred to the mesh synthesizer 234.

The image decoder 232 may generate the reconstructed texture map by decoding the transferred texture map-related bitstream. In this case, as a texture map reconstruction method, the present disclosure may use a decoding method corresponding to an encoding method used by the image encoder 212 in the mesh encoding apparatus. The reconstructed texture map may be transferred to the mesh synthesizer 234.

The mesh synthesizer 234 may reconstruct the original mesh by synthesizing a three-dimensional mesh by using the inputted vertex information, edge information, and texture map.

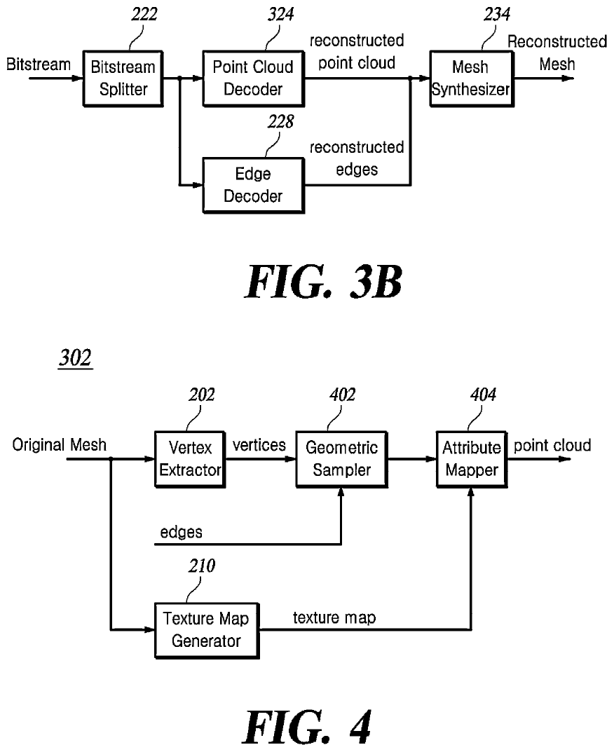

Referring now to FIGS. 3A and 3B, a method of utilizing point cloud coding is described as one example of a mesh encoding/decoding apparatus.

FIGS. 3A and 3B are block diagrams conceptually representing a mesh encoding apparatus and a mesh decoding apparatus according to at least one embodiment of the present disclosure.

In one embodiment, as exemplified in FIG. 3A, the mesh encoding apparatus may transform mesh information into a point cloud and then generate a bitstream by using a point cloud compression method. The mesh encoding apparatus may store the generated bitstream or transmit it to the mesh decoding apparatus. The mesh encoding apparatus may include all or part of an edge extractor 206, a point cloud transformer 302, a point cloud encoder 304, an edge encoder 208, and a bitstream synthesizer 214.

The edge extractor 206 may extract the edge information of a polygon from the original mesh information and represent it as an ASCII expression of data. The extracted edge data may be transferred to the edge encoder 208 and the point cloud transformer 302.

The point cloud transformer 302 may transform the inputted original mesh into a point cloud. The point cloud may be transferred to the point cloud encoder 304 and the edge encoder 208. The point cloud encoder 304 may encode the transferred point cloud to generate a bitstream. The generated bitstream may be transferred to the bitstream synthesizer 214. Detailed configurations of the point cloud transformer 302 and the point cloud encoder 304 are described below.

The edge encoder 208 may encode the inputted edge data to generate a bitstream. When encoding the edge data, the edge encoder 208 may utilize the data of the vertices provided by the point cloud transformer 302. The edge encoder 208 may utilize common data compression methods to generate a bitstream. Alternatively, the edge encoder 208 may generate the bitstream by using a common lossless compression method. The generated bitstream may be transferred to the bitstream synthesizer 214.

The bitstream synthesizer 214 may concatenate the delivered bitstreams to generate a single bitstream. The mesh encoding apparatus may store the generated bitstream or transfer it to the mesh decoding apparatus.

In another example, as illustrated in FIG. 3B, the mesh decoding apparatus may decode the point cloud from the delivered bitstream and then reconstruct the mesh information. The mesh decoding apparatus may include all or part of a bitstream splitter 222, a point cloud decoder 324, an edge decoder 228, and a mesh synthesizer 234.

The bitstream splitter 222 may separate the transferred bitstream into a point cloud-related bitstream and an edge-related bitstream. Each of the separated bitstreams may be transferred to the point cloud decoder 324 and the edge decoder 228.

The point cloud decoder 324 reconstructs a point cloud from the inputted point cloud-related bitstream. The reconstructed point cloud may be transferred to the mesh synthesizer 234. A detailed configuration of the point cloud decoder 324 is described below.

The edge decoder 228 may reconstruct the edge data by decoding the inputted edge-related bitstream. As an edge data reconstruction method, the present disclosure may use a decoding method corresponding to an edge data encoding method used in the mesh encoding apparatus. The reconstructed edge data may be transferred to the mesh synthesizer 234.

The mesh synthesizer 234 may reconstruct the original mesh by synthesizing a three-dimensional mesh by using the transferred point cloud and edge data. The mesh synthesizer 234 may use the edge data to generate planes of polygons and may use the attribute values of the point cloud closest to the planes to generate textures for the planes of the polygons.

Referring now to FIGS. 4-7, the structures and operations of the point cloud transformer 302 and the point cloud encoder 304 of FIG. 3A are described.

FIG. 4 is a block diagram conceptually illustrating a point cloud transformer according to at least one embodiment of the present disclosure.

The point cloud transformer 302 may include all or part of a vertex extractor 202, a geometric sampler 402, a texture map generator 210, and an attribute mapper 404.

The vertex extractor 202 extracts vertices from the original mesh. The extracted vertices may be transferred to the geometric sampler 402 and the edge encoder 208.

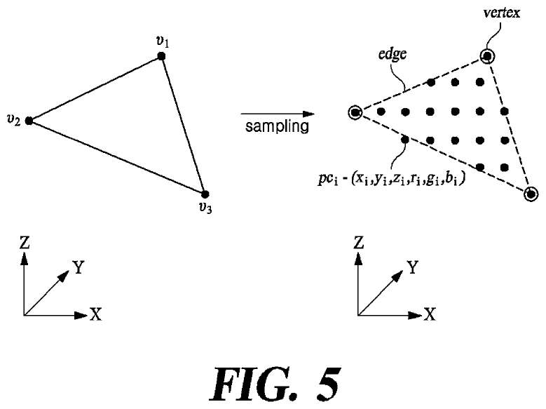

The geometry sampler 402 may generate planes of polygons by using the delivered vertices and edges. Then the geometry sampler 402 may sample the locations of points on the plane to generate geometric information for the point cloud. As illustrated in FIG. 5, the geometry sampler 402 may generate a plane in three-dimensional space by using the inputted vertices and edge data. The geometric sampler 402 may sample the generated plane in a uniform distribution to generate points at relevant locations. The geometric information of each point may be calculated based on the three-dimensional coordinates of the three vertices forming the plane. Alternatively, points may be generated based on the integer coordinates closest to the plane.

The geometry sampler 402 transfers the generated geometric information to the attribute mapper 404.

The texture map generator 210 generates a texture map by orthogonally projecting the texture information of the original mesh into the uv domain. Alternatively, if the texture information of the original mesh is in the form of a bitstream generated by image compression such as JPEG, JPEG2000, PNG, HEIF, or the like, the texture map generator 210 may decode the compressed image to generate a reconstructed texture map. The texture map generator 210 transfers texture map data including the generated texture map, information used for the orthogonal projection, and the like, to the attribute mapper 404.

The attribute mapper 404 may generate attribute information of the point cloud by using the transmitted geometric information of the point cloud and the transmitted texture map data. The generated point cloud, i.e., a point cloud represented by geometric information and attribute information, may be delivered to the point cloud encoder 304.

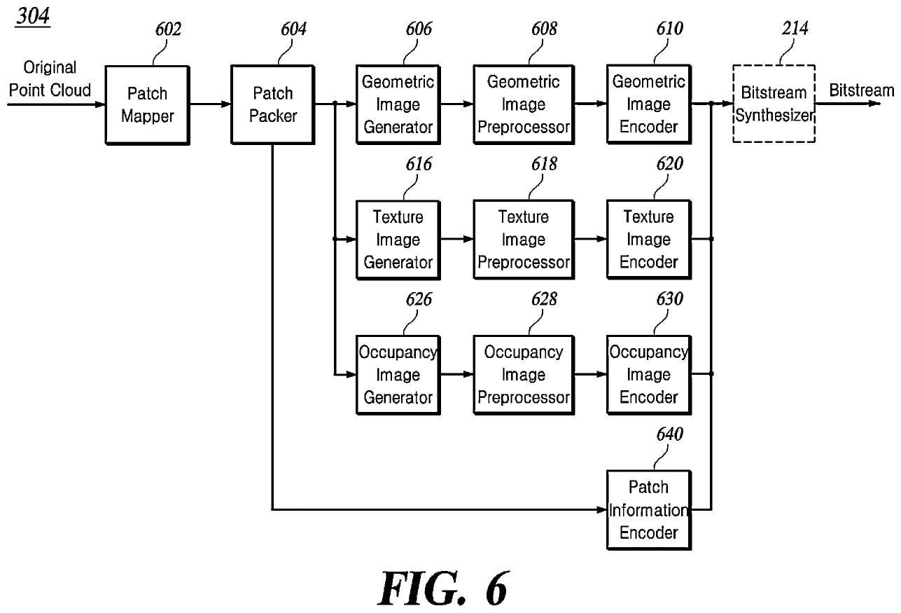

FIG. 6 is a block diagram conceptually illustrating a point cloud encoder according to at least one embodiment of the present disclosure.

The point cloud encoder 304 includes a patch generator 602, a patch packer 604, a geometric image generator 606, a geometric image preprocessor 608, a geometric image encoder 610, a texture image generator 616, a texture image preprocessor 618, a texture image encoder 620, an occupation image generator 626, an occupation image preprocessor 628, an occupation image encoder 630, and a patch information encoder 640 in whole or in part.

The patch generator 602 analyzes the point cloud, which is three-dimensional data, and classifies it into one or more groups. One categorized group is referred to as a patch. The points included in a patch have similar normal vectors, where the normal vector of a plane established by a point and its neighboring points is defined as the normal vector of that point. The generated patches may be transferred to the patch packer 604.

The patch packer 604 packs the patches by moving and rotating a plurality of delivered patches in three-dimensional space and mapping them to locations in a two-dimensional domain. Each of the patches may possess as patch information the parameters used for the transform from three dimensions to two dimensions. The patch information for each of the patches may further include a location mapped to two dimensions, the size of the patch in the two-dimensional domain, and the like. The patch information may be transferred to the patch information encoder 640. The packed patches may be transferred to the geometric image generator 606, the texture image generator 616, and the occupancy image generator 626.

The geometric image generator 606 utilizes the delivered packed patches to generate two geometric images. The geometric image is an image generated by mapping distance values between the points and the projected plane to locations into which the points of the patches are projected on a plane. In other words, a geometric image is a map of the depths between the points and a two-dimensional plane when a three-dimensional space is projected onto the plane. The two-dimensional plane may be one of an x-y plane, a y-z plane, and an x-z plane.

On the other hand, if the three-dimensional patch has a volume in three-dimensional space, two points may be projected to one two-dimensional location. In such a case, two depths may exist, so the geometric image generator 606 may generate separate geometric images for the depth information for the front and back. The generated geometric images may be transferred to the geometric image preprocessor 608.

The geometric image preprocessor 608 may preprocess the received geometric images before performing video encoding. The geometric images contain empty space where no points of the patches are projected, with no depth information defined in that space. If there are successive locations with and without depth information, the reduced continuity of the data can lead to poor prediction performance during video encoding. To avoid this, the geometric image preprocessor 608 may apply padding to locations where depth information is not present by using values from nearby locations where depth information is present. The geometric image preprocessor 608 may transfer the padded geometric images to the geometric image encoder 610.

The geometric image encoder 610 may encode the two delivered geometric images by using a video compression technique to generate a bitstream. For this purpose, video compression techniques such as H.264/AVC, H.265/HEVC, H.266/VVC, and the like may be used. Meanwhile, the mesh or point cloud may be inputted to the mesh encoding apparatus continuously over time. Thus, in this case, the geometric image may be efficiently compressed, the same as for conventional video, where inter prediction is used rather than image coding using only intra prediction. The generated bitstream may be transferred to the bitstream synthesizer 214.

The texture image generator 616 may generate a texture image by using the inputted packed patches. Here, the texture image is an image an image generated by mapping the attribute values of points to locations into which the points are projected on a plane when the points in the patches are orthogonally projected to the two-dimensional plane. The generated texture image may be transferred to the texture image preprocessor 618.

The texture image preprocessor 618 applies padding to the unoccupied areas by the points on the two-dimensional texture image to generate a padded image. The texture image preprocessor 618 may apply padding to the texture image by using a filter or using a push-pull padding method. The padded texture image may be transferred to the texture image encoder 620.

Meanwhile, the push-pull padding method is adapted to pad the boundaries of the empty space in the image by downsampling the image and then upsampling the image.

The texture image encoder 620 may generate a bitstream by encoding the transmitted texture image by using a video compression technique. In this case, video compression techniques such as H.264/AVC, H.265/HEVC, H.266/VVC, and the like may be used. Alternatively, the texture image encoder 620 may utilize a common image codec to generate the bitstream. The generated bitstream may be transferred to the bitstream synthesizer 214.

The occupancy image generator 626 may generate an occupancy image by using the delivered packed patches. Here, the occupancy image is a binary map representing the occupancy or inoccupancy of points in a region on a two-dimensional plane when the three-dimensional patch is orthogonally projected to the two-dimensional plane. The generated occupancy image may be transferred to the occupancy image preprocessor 628.

The occupancy image preprocessor 628 may apply preprocessing, such as downsampling, reduction, and expansion, to the inputted occupancy image. The preprocessed occupancy image may be transferred to the occupancy image encoder 630.

The occupancy image encoder 630 may generate a bitstream by encoding the delivered occupancy image. As a method for generating the bitstream of the occupancy image, a common video codec may be used. Alternatively, binary arithmetic coding may be used or gzip, a common data compression method, may be used. The generated bitstream may be transferred to the bitstream synthesizer 214.

The patch information encoder 640 may entropy-code the delivered patch data to generate a bitstream. The generated bitstream may be transferred to the bitstream generator 214.

The bitstream generator 214 may concatenate all of the delivered bitstreams to generate a single bitstream that is the point cloud compressed.

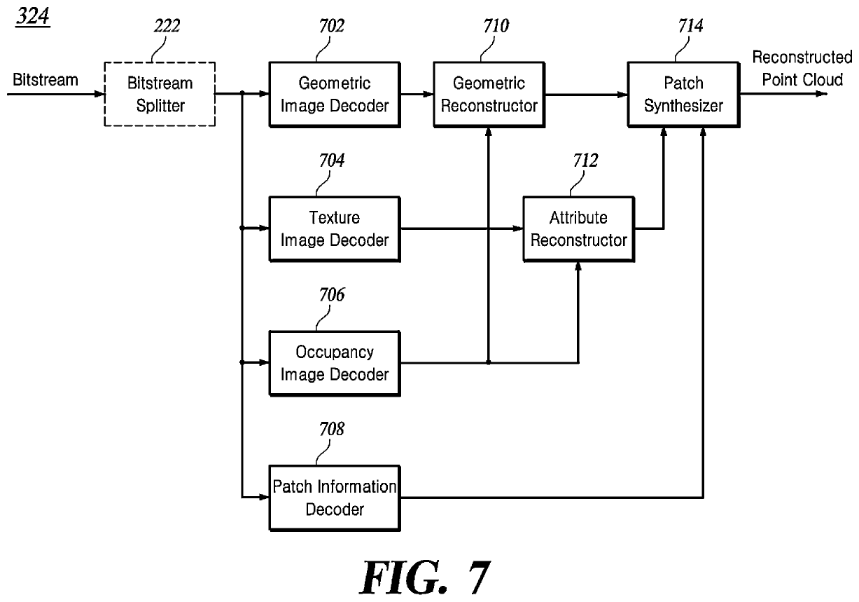

Referring now to FIG. 7, the structure and operation of the point cloud decoder 324 shown in FIG. 3B are described.

FIG. 7 is a block diagram conceptually illustrating a point cloud decoder according to at least one embodiment of the present disclosure.

The point cloud decoder 324 may include all or some of a bitstream splitter 222, a geometric image decoder 702, a texture image decoder 704, an occupancy image decoder 706, a patch information decoder 708, a geometric reconstructor 710, an attribute reconstructor 712, and a patch synthesizer 714.

After the bitstream splitter 222 obtains the bitstream generated by compressing the point cloud, the bitstream splitter 222 separates the bitstream into a geometric image-related bitstream, a texture image-related bitstream, an occupancy image-related bitstream, and a patch information-related bitstream. The bitstream splitter 222 may transfer each of the separated bitstreams to the geometric image decoder 702, the texture image decoder 704, the occupancy image decoder 706, and the patch information decoder 708.

The geometric image decoder 702 may reconstruct the geometric image by decoding the transferred geometric image-related bitstream. As a method of decoding the geometric image, a decoding method corresponding to the encoding method used in the geometric image encoder 610 may be used. The reconstructed geometric image may be transferred to the geometric reconstructor 710.

The texture image decoder 704 may reconstruct the texture image by decoding the transferred texture image-related bitstream. As a method of decoding the texture image, a decoding method corresponding to the encoding method used in the texture image encoder 620 may be used. The reconstructed texture image may be transferred to the attribute reconstructor 712.

The occupancy image decoder 706 may decode the transferred occupancy image-related bitstream to generate an occupancy image. If a video decoding method is used to decode the occupancy image, the occupancy image decoder 706 may further transform the bit depth of the image to one. Alternatively, if a general compression method is used, the occupancy image decoder 706 may generate a binary map. The reconstructed occupancy image may be transferred to the geometric reconstructor 710 and the attribute reconstructor 712.

The patch information decoder 708 may reconstruct the patch information by entropy-decoding the transferred patch information-related bitstream. The reconstructed patch information may be transferred to the patch synthesizer 714.

The geometric reconstructor 710 may reconstruct the three-dimensional geometric information of the patch by using the transferred geometric image and the occupancy image. For example, the geometric reconstructor 710 may reconstruct the geometric information by using the occupancy image to determine an original location where depth information exists and then extracting the geometric information by using the depth information at that location. The reconstructed geometric information may be transferred to the patch synthesizer 714.

The attribute reconstructor 712 may reconstruct the attribute (texture) information of the patch by using the transferred texture image and occupancy image. The reconstructed attribute information may be transferred to the patch synthesizer 714.

The patch synthesizer 714 may synthesize the three-dimensional patch by synthesizing the transmitted patch geometric information, the patch attribute information, and the patch information, thereby reconstructing the point cloud.

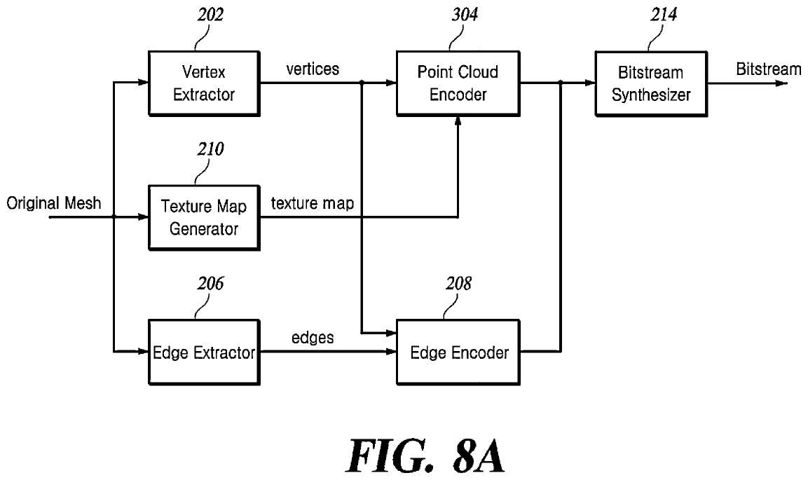

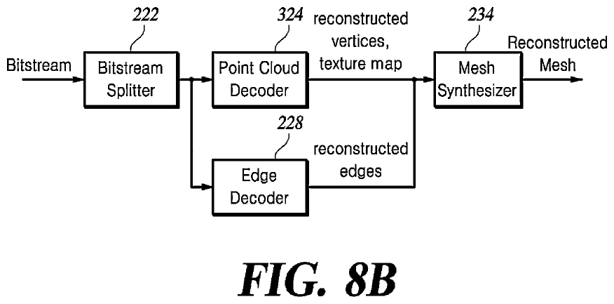

Hereinafter, other embodiments of a mesh encoding/decoding apparatus utilizing point cloud coding are described by using the illustrations of FIGS. 8A and 8B.

FIGS. 8A and 8B are block diagrams conceptually representing a mesh encoding apparatus and a mesh decoding apparatus according to other embodiments of the present disclosure.

In another embodiment, as illustrated in FIG. 8A, the mesh encoding apparatus may generate a bitstream by using a point cloud compression method based on vertex information and a texture map of the mesh. The mesh encoding apparatus may store the generated bitstream or transmit it to the mesh decoding apparatus. The mesh encoding apparatus may include all or part of a vertex extractor 202, a texture map generator 210, a point cloud encoder 304, an edge extractor 206, an edge encoder 208, and a bitstream synthesizer 214.

The vertex extractor 202 extracts such data as ASCII expressions of vertices, texture vertices, and normal vectors of vertices from the original mesh information. The extracted vertex data may be transferred to the point cloud encoder 304 and the edge encoder 208.

The texture map generator 210 may generate a two-dimensional texture map by orthogonally projecting the textures of the planes of the three-dimensional object of the original mesh into the uv domain. Alternatively, if the texture information of the original mesh is in the form of a bitstream generated by image compression such as JPEG, JPEG2000, PNG, HEIF, or the like, the texture map generator 210 may decode the compressed image to generate a reconstructed texture map. The generated texture map may be transferred to the point cloud encoder 304.

The point cloud encoder 304 regards the inputted vertex data and texture map as a point cloud and encodes them by using a point cloud compression method to generate a bitstream. The generated bitstream may be transferred to the bitstream synthesizer 214. A detailed configuration of the point cloud encoder 304 is described below.

The edge extractor 206 may extract polygonal edge data from the original mesh information and transfer it to the edge encoder 208. The edge encoder 208 may compress the received edge data to generate a bitstream. In addition, the edge encoder 208 may utilize data of the vertices generated by the vertex extractor 202 when encoding the edge data. The edge encoder 208 may utilize common data compression methods to encode the edge data. Alternatively, the edge data uncompressed may be packed on a per byte basis to generate a bitstream.

In another embodiment, the edge encoder 208 may generate the bitstream by using a common lossless compression method. For example, edgebreaker, a common polygonal connectivity compression method, may be utilized. Alternatively, the edge encoder 208 may generate the bitstream by selectively applying a common data compression method to some of the edge data and an edgebreaker to the remaining edge data. The generated bitstream may be transferred to the bitstream synthesizer 214.

The bitstream synthesizer 214 may concatenate all of the inputted bitstreams to generate a single bitstream. The mesh encoding apparatus may transfer the generated bitstream to the mesh decoding apparatus.

Meanwhile, as illustrated in FIG. 8B, the mesh decoding apparatus may decode the point cloud from the delivered bitstream, and then reconstruct the mesh information. The mesh decoding apparatus may include all or part of a bitstream splitter 222, a point cloud decoder 324, an edge decoder 228, and a mesh synthesizer 234.

The bitstream splitter 222 may separate the transferred bitstream into a point cloud-related bitstream and an edge-related bitstream, and transfer the separated bitstreams to the point cloud decoder 324 and the edge decoder 228, respectively. The point cloud decoder 324 may decode the delivered bitstream to reconstruct vertex data and texture map. The reconstructed vertex data and texture map may be transferred to the mesh synthesizer 234. Further configuration of the point cloud decoder 324 is described below.

The edge decoder 228 may reconstruct the edge data by decoding the transferred edge-related bitstream. The reconstructed edge information may be transferred to the mesh synthesizer 234. Here, as a method of decoding the edge data, the present disclosure may use a decoding method corresponding to the encoding method used by the edge encoder 208 in the mesh encoding apparatus.

The mesh synthesizer 214 may synthesize a three-dimensional mesh by using the inputted vertex data, edge data, and texture map, thereby reconstructing the original mesh.

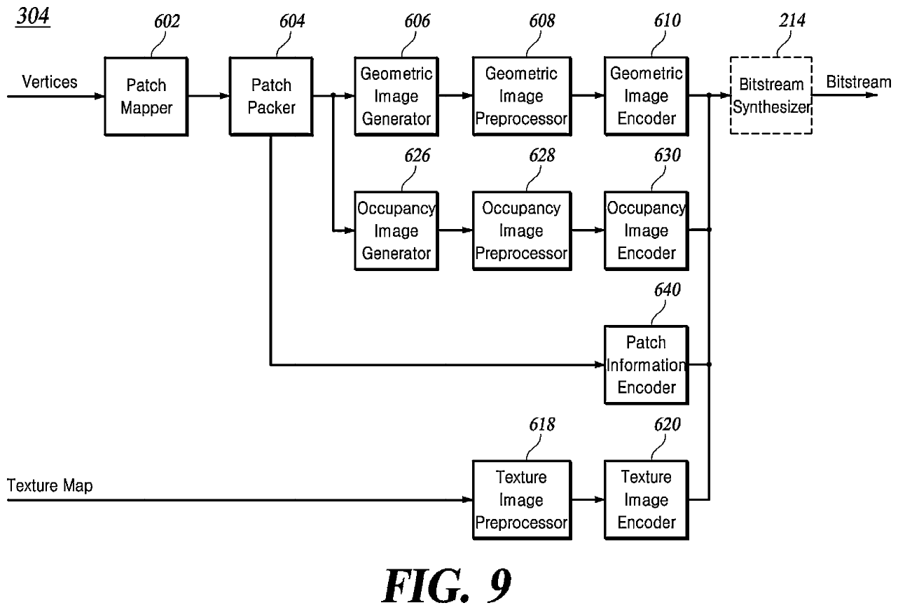

Referring now to FIG. 9, the structure and operation of the point cloud encoder 304 as presented in FIG. 8A are described.

FIG. 9 is a block diagram conceptually illustrating a point cloud encoder according to other embodiments of the present disclosure.

The point cloud encoder 304 includes a patch generator 602, a patch packer 604, a geometric image generator 606, a geometric image preprocessor 608, a geometric image encoder 610, an occupancy image generator 626, an occupancy image preprocessor 628, an occupancy image encoder 630, a patch information encoder 640, a texture image preprocessor 618, a texture image encoder 620, and a bitstream synthesizer 214 in whole or in part.

The patch generator 602 regards the vertex data, i.e., the vertices, as a point cloud, and analyzes the vertices to classify them into one or more groups, i.e., patches. The categorized patches may be transferred to the patch packer 604.

The patch packer 604 packs the patches by moving and rotating a plurality of delivered patches in the three-dimensional space and mapping them to locations in the two-dimensional domain. Each of the patches may possess as patch information the parameters used to transform from three dimensions to two dimensions. The patch information for each of the patches may further include a location mapped to two dimensions, the size of the patch in the two-dimensional domain, and the like. The patch information may be transferred to the patch information encoder 640. The packed patches may be transferred to the geometric image generator 606 and the occupancy image generator 626.

Each of the patches may have as patch information the parameters used in the three-dimensional to two-dimensional transformation. The patch information for each of the patches may further include a location mapped to two dimensions, a size of the patch in the two-dimensional domain, and the like.

The geometric image generator 606 generates two geometric images by using the transferred packed patches. As described above, the geometric image is an image generated by mapping distance values between the points and the projected plane, i.e., depths to locations into which the points of the patches are projected on a plane. Further, if the three-dimensional patch has a volume in three-dimensional space, there may be two depths, as described above, so the geometric image generator 606 may generate separate geometric images for the depth information for the front and back. The generated geometric images may be transferred to the geometric image preprocessor 608.

The geometric image preprocessor 608 may preprocess the delivered geometric images before performing image encoding. As described above, the geometric image preprocessor 608 may utilize values from locations with surrounding depth information being present to apply padding to locations where depth information is absent. The geometric image preprocessor 608 may transfer the padded geometric images to the geometric image encoder 610.

The geometric image encoder 610 may encode the two delivered geometric images by using video compression techniques to generate a bitstream. For this purpose, video compression techniques such as H.264/AVC, H.265/HEVC, H.266/VVC, and the like may be used. Meanwhile, the mesh or point cloud may be continuously inputted to the mesh encoding apparatus over time, so that the geometric image may be efficiently compressed, as described above, the same as conventional video. The generated bitstream may be transferred to the bitstream synthesizer 214.

The occupancy image generator 626 may generate an occupancy image by using the delivered packed patches. As described above, the occupancy image is a binary map representing the occupancy or inoccupancy of points in a region on a two-dimensional plane when the three-dimensional patch is orthogonally projected to the particular plane. The generated occupancy image may be transferred to the occupancy image preprocessor 628.

The occupancy image preprocessor 628 may apply preprocessing, such as downsampling, reduction, and expansion, to the inputted occupancy image. The preprocessed occupancy image may be transferred to the occupancy image encoder 630.

The occupancy image encoder 630 may generate a bitstream by encoding the delivered occupancy image. As a method of generating the bitstream of the occupancy image, a common video codec, binary arithmetic coding, or gzip, a common data compression method, may be used. The generated bitstream may be transferred to the bitstream synthesizer 214.

The patch information encoder 640 may entropy-code the delivered patch data to generate a bitstream. The generated bitstream may be transferred to the bitstream generator 214.

The texture image preprocessor 618 may use the surrounding texture to pad a non-textured portion of a two-dimensional texture image (i.e., a texture map). The texture image preprocessor 618 may apply padding to the texture image by using a filter or using a push-pull padding method. The padded texture image may be transferred to the texture image encoder 620.

The texture image encoder 620 may encode the delivered texture image by using a video codec to generate a bitstream. Alternatively, the texture image encoder 620 may utilize a common image codec to generate the bitstream. The generated bitstream may be transferred to the bitstream synthesizer 214.

The bitstream synthesizer 214 may concatenate all of the delivered bitstreams to generate a single bitstream that is the point cloud compressed, which is implemented by the vertices and a texture map.

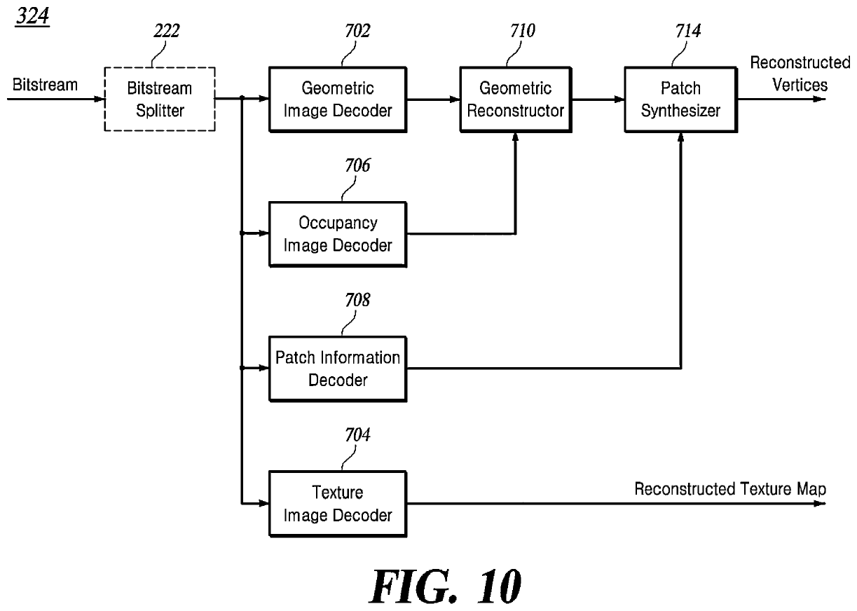

Referring now to FIG. 10, the structure and operation of the point cloud decoder 324 as shown in FIG. 8B are described.

FIG. 10 is a block diagram conceptually illustrating a point cloud decoder according to other embodiments of the present disclosure.

The point cloud decoder 324 may include all or part of a bitstream splitter 222, a geometric image decoder 702, an occupancy image decoder 706, a geometric reconstructor 710, a patch information decoder 708, a patch synthesizer 714, and a texture image decoder 704.

The bitstream splitter 222, after obtaining the bitstream generated by compressing the point cloud, partitions the bitstream into a geometric image-related bitstream, an occupancy image-related bitstream, a patch information-related bitstream, and a texture image-related bitstream. The bitstream splitter 222 may transfer each of the separated bitstreams to the geometric image decoder 702, the occupancy image decoder 706, the patch information decoder 708, and the texture image decoder 704.

The geometric image decoder 702 may decode the transferred geometric image-related bitstream to reconstruct the geometric image. As a method of decoding the geometric image, a decoding method corresponding to the encoding method used in the geometric image encoder 610 may be used. The reconstructed geometric image may be transferred to the geometric reconstructor 710.

The occupancy image decoder 706 may decode the transferred occupancy image-related bitstream to generate an occupancy image. If a video decoding method is used to decode the occupancy image, the occupancy image decoder 706 may further transform the bit depth of the image to one. Alternatively, if a common compression method is used, the occupancy image decoder 706 generates a binary map. The reconstructed occupancy image may be transferred to the geometric reconstructor 710.

The patch information decoder 708 may reconstruct the patch information by entropy-decoding the transferred patch information-related bitstream. The reconstructed patch information may be transferred to the patch synthesizer 714.

The texture image decoder 704 may reconstruct the texture image by decoding the transferred texture image-related bitstream. As a method of decoding the texture image, a decoding method corresponding to the encoding method used in the texture image encoder 620 may be used.

The geometry reconstructor 710 may reconstruct three-dimensional geometric information of the points of the patch by using the transmitted geometric image and the occupancy image. The reconstructed geometric information may be transferred to the patch synthesizer 714.

The patch synthesizer 714 may generate patches in three-dimensional space by using the transmitted patch geometric information and patch information. In this case, the points of the patches may represent vertices.

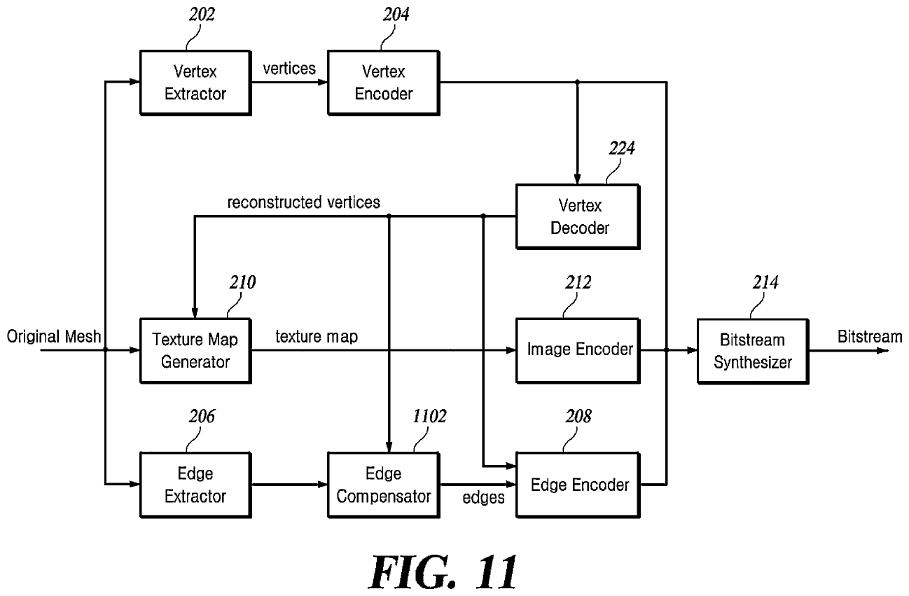

Referring now to FIG. 11, a mesh encoding apparatus utilizing reconstructed vertex information is described. As a reconstruction device corresponding to the mesh encoding apparatus illustrated in FIG. 11, the mesh decoding apparatus illustrated in FIG. 2B may be utilized.

FIG. 11 is a block diagram conceptually representing a mesh encoding apparatus utilizing reconstructed vertex information, according to yet another embodiment of the present disclosure.

In yet another embodiment, as illustrated in FIG. 11, the mesh encoding apparatus may separate a mesh into vertex information, texture maps, and edge information, and then encode them by using the reconstructed vertex information to generate a bitstream. The mesh encoding apparatus may store the generated bitstream or transmit it to the mesh decoding apparatus. The mesh encoding apparatus may include all or part of a vertex extractor 202, a vertex encoder 204, a vertex decoder 224, an edge extractor 206, an edge compensator 1102, an edge encoder 208, a texture map generator 210, an image encoder 212, and a bitstream synthesizer 214.

The vertex extractor 202 extracts such data as ASCII expressions from the original mesh information, including coordinate values of vertices, normal vectors of vertices, and coordinate values of texture vertices. The extracted data may be transferred to the vertex encoder 204. The vertex encoder 204 may compress the vertex data of the inputted mesh to generate a bitstream. As described above, the vertex encoder 204 may utilize a conventional lossless data compression method to compress the vertex information. In another embodiment, the vertex encoder 204 may generate a bitstream by packing on a per byte basis the vertex data uncompressed. The generated bitstream may be transferred to the bitstream synthesizer 214 and the vertex decoder 224.

The vertex decoder 224 may decode the vertex-related bitstream generated by the vertex encoder 204 to reconstruct the vertex data and texture vertex data. The reconstructed vertex data may be transferred to the texture map generator 210, the edge compensator 1102, and the edge encoder 208.

Using the original mesh and the reconstructed vertex data, the texture map generator 210 may generate a two-dimensional texture map by orthogonally projecting the texture of a plane of a three-dimensional object into the uv domain. Alternatively, if the texture information of the original mesh is in the form of a bitstream generated by image compression such as JPEG, JPEG2000, PNG, HEIF, or the like, the texture map generator 210 may decode the compressed image to generate a reconstructed texture map. The generated texture map may be transferred to the image encoder 212. The image encoder 212 may compress the inputted texture map to generate a bitstream. In doing so, the image encoder 212 may utilize image compression methods or video compression techniques, such as those described above. The generated bitstream may be transferred to the bitstream synthesizer 214.

The edge extractor 206 extracts edge data of a polygon from the original mesh information and transfers it to the edge compensator 1102. The edge compensator 1102 corrects the extracted edge data by using the transferred reconstructed vertex data. The corrected edge data may be transferred to the edge encoder 208. The edge encoder 208 may compress the edge data to generate a bitstream. Additionally, the edge encoder 208 may utilize the reconstructed vertex data generated by the vertex decoder 224 when encoding the edge data. Alternatively, the edge encoder 208 may generate the bitstream by packing on a per byte basis the edge data uncompressed.

As described above, the edge encoder 208 may, in another embodiment, utilize a common lossless compression method to generate the bitstream. For example, edgebreaker, a common polygonal connectivity compression method, may be utilized. Alternatively, the edge encoder 208 may generate the bitstream by selectively applying a common data compression method to some of the edge data and the edgebreaker to the remaining edge data. The generated bitstream may be transferred to the bitstream synthesizer 214.

The bitstream synthesizer 214 may concatenate all of the inputted bitstreams to generate a single bitstream. The mesh encoding apparatus may transfer the generated bitstream to the mesh decoding apparatus.

The following describes an encoding/decoding method performed by a mesh encoding/decoding apparatus utilizing point cloud coding, illustrated in FIGS. 3A and 3B.

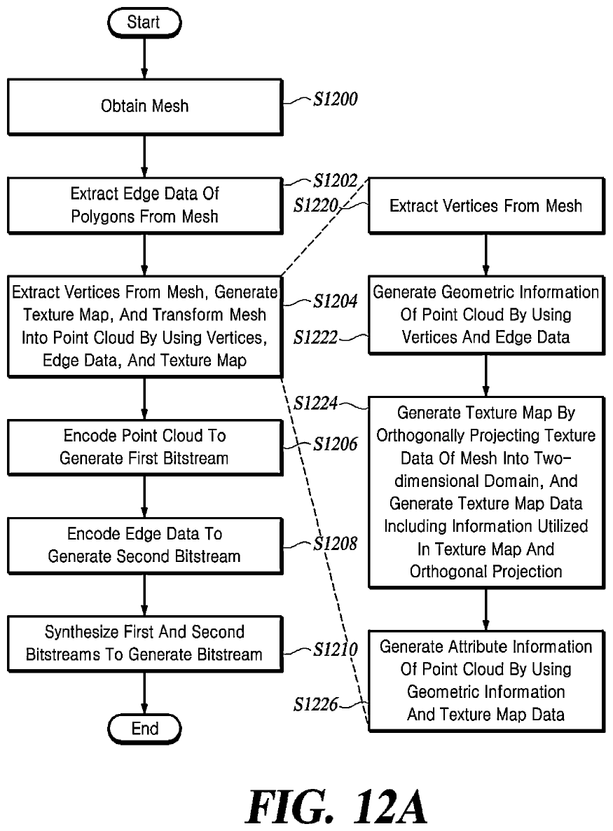

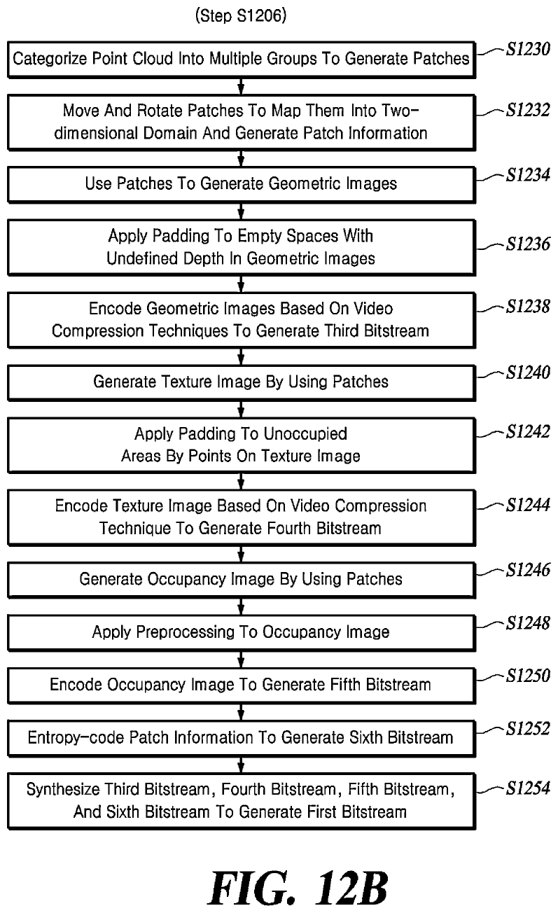

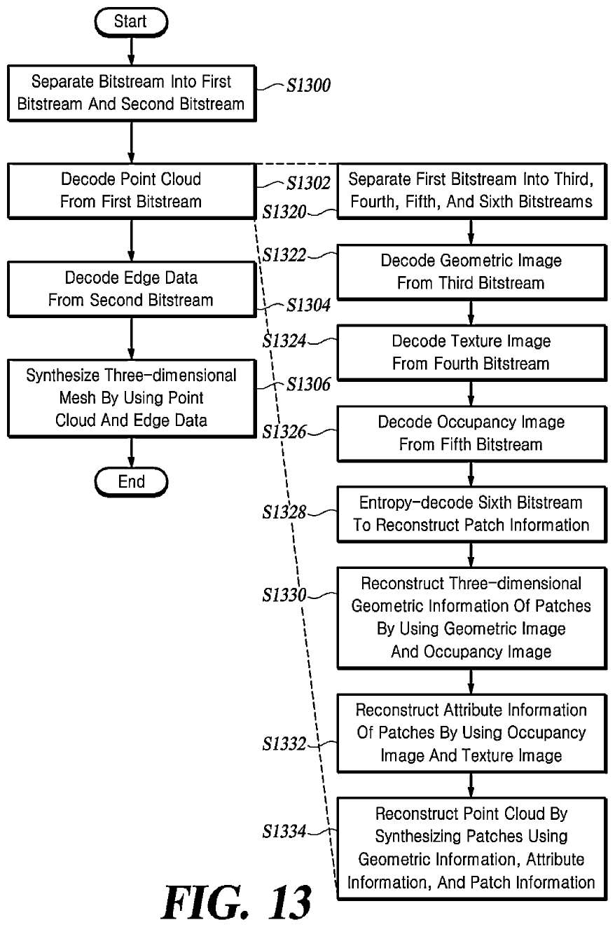

FIGS. 12A and 12B are flowcharts of a mesh encoding method according to at least one embodiment of the present disclosure.

The mesh encoding apparatus obtains a mesh (S1200).

The mesh encoding apparatus extracts edge data of polygons from the mesh (S1202). The edge data may be an ASCII expression of data.

The mesh encoding apparatus extracts vertices from the mesh, generates a texture map, and transforms the mesh into a point cloud by using the vertices, edge data, and texture map (S1204). The points in the point cloud may be represented by geometric information and attribute information.

The following describes in detail Step S1204 by which the mesh encoding apparatus transforms the mesh into the point cloud.

The mesh encoding apparatus extracts vertices from the mesh (S1220).

The mesh encoding apparatus generates geometric information of the point cloud by using the vertices and edge data (S1222). The mesh encoding apparatus may generate planes of polygons by using the vertices and edge data. Then the mesh encoding apparatus may sample the locations of points on the planes to generate the geometric information of the point cloud.

The mesh encoding apparatus generates a texture map by orthogonally projecting the texture data of the mesh into a two-dimensional domain and generates texture map data including information utilized in the texture map and orthogonal projection (S1224).

The mesh encoding apparatus generates attribute information of the point cloud by using the geometric information and the texture map data (S1226).

The mesh encoding apparatus encodes the point cloud to generate a first bitstream (S1206).

The following describes in detail Step S1206 by which the mesh encoding apparatus encodes the point cloud.

The mesh encoding apparatus categorizes the point cloud into a plurality of groups to generate patches (S1230).

The mesh encoding apparatus moves and rotates the patches to map them into a two-dimensional domain and generates patch information (S1232). The patch information includes parameters for mapping the patches into the two-dimensional domain, locations where the patches are mapped, and the size of each patch in the two-dimensional domain.

The mesh encoding apparatus uses the patches to generate geometric images (S1234). The geometric images are a map of the depths between the points in the patches and a two-dimensional plane when the patches are orthogonally projected to the two-dimensional plane. The two-dimensional plane may be one of an x-y plane, a y-z plane, and an x-z plane.

The mesh encoding apparatus applies padding to empty spaces with undefined depth in the geometric images (S1236). The mesh encoding apparatus may apply padding to locations where no depth information exists by utilizing values from nearby locations where depth information exists.

The mesh encoding apparatus encodes the geometric images based on a video compression technique to generate a third bitstream (S1238). For this purpose, video compression techniques such as H.264/AVC, H.265/HEVC, H.266/VVC, and the like may be used.

The mesh encoding apparatus generates a texture image by using the patches (S1240). Here, the texture image is an image generated by mapping the attribute values of points to locations into which the points are projected on a plane when the points in the patches are orthogonally projected to the two-dimensional plane.

The mesh encoding apparatus applies padding to the unoccupied areas by the points on the texture image (S1242). The mesh encoding apparatus may apply padding to the texture image by using a filter or utilizing a push-pull padding method.

The mesh encoding apparatus encodes the texture image based on a video compression technique to generate a fourth bitstream (S1244). Video compression techniques such as H.264/AVC, H.265/HEVC, H.266/VVC, and the like may be used. Alternatively, the mesh encoding apparatus may utilize a common image codec to generate the bitstream.

The mesh encoding apparatus generates an occupancy image by using patches (S1246). The occupancy image is a binary map representing the occupancy or inoccupancy by points in the patches in a region on a particular plane when the patches are orthogonally projected to the plane.

The mesh encoding apparatus applies preprocessing to the occupancy image (S1248). Here, the preprocessing is downsampling, reducing, or expanding the occupancy image.

The mesh encoding apparatus encodes the occupancy image to generate a fifth bitstream (S1250). As a method for generating the bitstream of the occupied image, a common video codec may be used. Alternatively, a common data compression method may be used.

The mesh encoding apparatus entropy-codes the patch information to generate a sixth bitstream (S1252).

The mesh encoding apparatus synthesizes the third bitstream, the fourth bitstream, the fifth bitstream, and the sixth bitstream to generate the first bitstream (S1254).

The mesh encoding apparatus encodes the edge data to generate the second bitstream (S1208). The mesh encoding apparatus may utilize vertices when encoding the edge data. The mesh encoding apparatus may utilize common data compression methods to generate the bitstream. The mesh encoding apparatus may generate the bitstream by using a common lossless compression method.

The mesh encoding apparatus generates a bitstream by synthesizing the first bitstream and the second bitstream (S1210). The mesh encoding apparatus may store the generated bitstream or transfer it to the mesh decoding apparatus.

FIG. 13 is a flowchart of a mesh decoding method according to at least one embodiment of the present disclosure.

The mesh decoding apparatus separates the delivered bitstream into a first bitstream and a second bitstream (S1300). Here, the first bitstream has been obtained by encoding the point cloud representing the mesh and the second bitstream has been obtained by encoding with edge data of the mesh.

The mesh decoding apparatus decodes the point cloud from the first bitstream (S1302).

The following describes in detail Step S1302 by which the mesh decoding apparatus decodes the point cloud.

The mesh decoding apparatus separates the first bitstream into a third bitstream, a fourth bitstream, a fifth bitstream, and a sixth bitstream (S1320).

The mesh decoding apparatus decodes a geometric image from the third bitstream (S1322). As a method for decoding the geometric image, a decoding method corresponding to a geometric image encoding method used in the mesh encoding apparatus may be used.

The mesh decoding apparatus decodes a texture image from the fourth bitstream (S1324). As a method for decoding the texture image, a decoding method corresponding to a texture image encoding method used in the mesh encoding apparatus may be used.

The mesh decoding apparatus decodes an occupancy image from the fifth bitstream (S1326). When a common compression method is used, the mesh decoding apparatus may generate a binary map.

The mesh decoding apparatus entropy-decodes the sixth bitstream to reconstruct the patch information (S1328).

The mesh decoding apparatus reconstructs the three-dimensional geometric information of the patches by using the geometric image and the occupancy image (S1330). For example, the mesh decoding apparatus may reconstruct the geometric information by determining an original location where depth information exists and then extracting the geometric information by using the depth information at that location.

The mesh decoding apparatus reconstructs the attribute information of the patches by using the occupancy image and the texture image (S1332).

The mesh decoding apparatus reconstructs the point cloud by synthesizing the patches using the geometric information, the attribute information, and the patch information (S1334).

The mesh decoding apparatus decodes edge data from the second bitstream (S1304). As an edge data reconstruction method, a decoding method corresponding to an edge data encoding method used in the mesh encoding apparatus may be used.

The mesh decoding apparatus synthesizes a three-dimensional mesh by using the point cloud and the edge data (S1306). The mesh decoding apparatus may reconstruct the mesh by generating planes of polygons using the edge data and by generating textures of the planes using attribute values in the point cloud that are closest to the planes.

The following describes an encoding/decoding method performed by another mesh encoding/decoding apparatus utilizing point cloud coding, illustrated in FIGS. 8A and 8B.

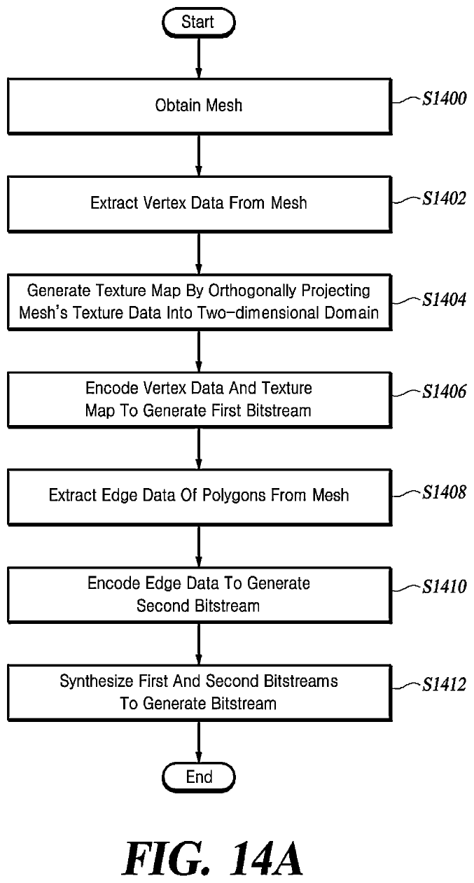

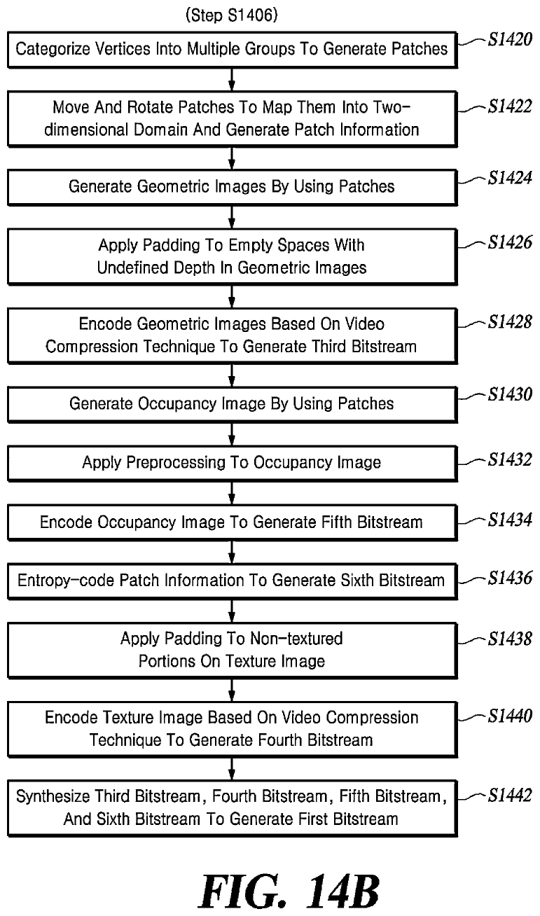

FIG. 14A and FIG. 14B are flowcharts of a mesh encoding method according to another embodiment of the present disclosure.

The mesh encoding apparatus obtains a mesh (S1400).

The mesh encoding apparatus extracts vertex data from the mesh (S1402). The mesh encoding apparatus may extract such data as ASCII expressions of vertices, texture vertices, normal vectors of vertices, and the like from the mesh information.

The mesh encoding apparatus generates a texture map by orthogonally projecting the mesh's texture data into a two-dimensional domain (S1404).

The vertex data and the texture map may be regarded as a point cloud.

The mesh encoding apparatus encodes the vertex data and the texture map to generate a first bitstream (S1406).

The following describes in detail Step S1406 by which the mesh encoding apparatus encodes the point cloud.

The mesh encoding apparatus regards the vertex data, i.e., the vertices, as a point cloud and categorizes the vertices into a plurality of groups to generate patches (S1420).

The mesh encoding apparatus moves and rotates the patches to map them into a two-dimensional domain, and generates patch information (S1422). The patch information includes parameters for mapping the patches into the two-dimensional domain, locations where the patches are mapped, and a size of each patch in the two-dimensional domain.

The mesh encoding apparatus uses the patches to generate geometric images (S1424). The geometric images are a map of the depths between the points in the patches and a two-dimensional plane when the patches are orthogonally projected to the two-dimensional plane.

The mesh encoding apparatus applies padding to empty spaces with undefined depth in the geometric images (S1426). The mesh encoding apparatus may utilize values from nearby locations where depth information exists to apply padding to locations where depth information is absent.

The mesh encoding apparatus encodes the geometric images based on a video compression technique to generate a third bitstream (S1428). In this case, video compression techniques such as H.264/AVC, H.265/HEVC, H.266/VVC, and the like may be used.

The mesh encoding apparatus generates an occupancy image by using the patches (S1430). The occupancy image is a binary map representing the occupancy or inoccupancy by points in the patches in a region on a particular plane when the patches are orthogonally projected to that plane.

The mesh encoding apparatus applies preprocessing to the occupancy image (S1432). Here, the preprocessing is downsampling, reduction, or expansion performed on the occupancy image.

The mesh encoding apparatus encodes the occupancy image to generate a fifth bitstream (S1434). As a method of generating the bitstream of the occupancy image, a common video codec may be used. Alternatively, a common data compression method may be used.

The mesh encoding apparatus entropy-codes the patch information to generate a sixth bitstream (S1436).

The mesh encoding apparatus applies padding to non-textured portions on the texture image (i.e., texture map) (S1438). The mesh encoding apparatus may apply padding to the texture image by using a filter or utilizing a push-pull padding method.

The mesh encoding apparatus encodes the texture image based on a video compression technique to generate a fourth bitstream (S1440). Video compression techniques such as H.264/AVC, H.265/HEVC, H.266/VVC, and the like may be used. Alternatively, the mesh encoding apparatus may utilize a common image codec to generate the bitstream.

The mesh encoding apparatus synthesizes the third bitstream, the fourth bitstream, the fifth bitstream, and the sixth bitstream to generate the first bitstream (S1442).

The mesh encoding apparatus extracts edge data of polygons from the mesh (S1408). The edge data may be an ASCII expression of data.

The mesh encoding apparatus encodes the edge data to generate a second bitstream (S1410). The mesh encoding apparatus may utilize the vertex data when encoding the edge data. The mesh encoding apparatus may utilize common data compression methods to generate the bitstream. The mesh encoding apparatus may utilize common lossless compression methods to generate the bitstream.

The mesh encoding apparatus synthesizes the first bitstream and the second bitstream to generate a bitstream (S1412). The mesh encoding apparatus may store the generated bitstream or transmit it to the mesh decoding apparatus.

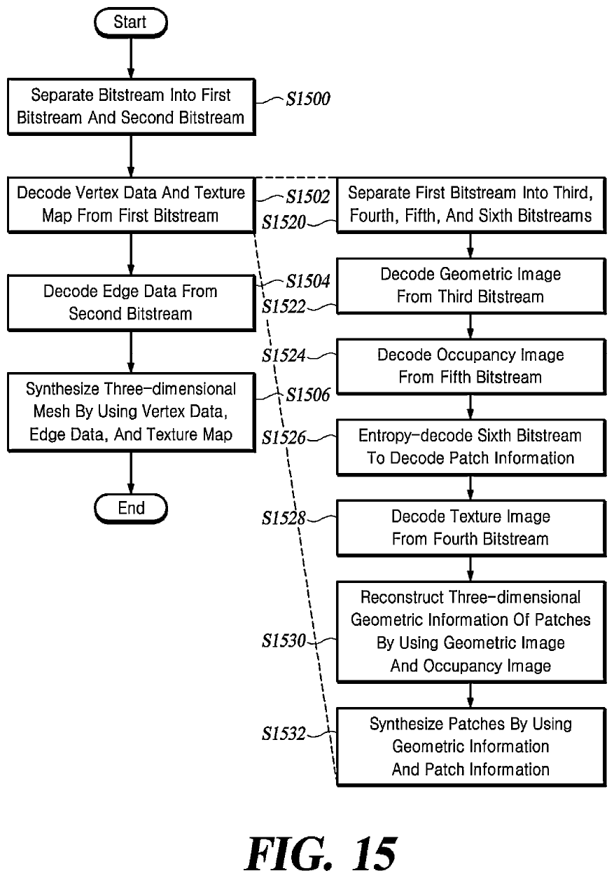

FIG. 15 is a flowchart of a mesh decoding method according to another embodiment of the present disclosure.

The mesh decoding apparatus separates the delivered bitstream into a first bitstream and a second bitstream (S1500). Here, the first bitstream has been obtained by encoding a point cloud composed of vertex data and a texture map of the mesh and the second bitstream has been obtained by encoding edge data of the mesh.

The mesh decoding apparatus decodes the vertex data and the texture map from the first bitstream (S1502).

The following describes in detail Step S1502 by which the mesh decoding apparatus decodes the vertex data and the texture map.

The mesh decoding apparatus separates the first bitstream into a third bitstream, a fourth bitstream, a fifth bitstream, and a sixth bitstream (S1520).

The mesh decoding apparatus decodes a geometric image from the third bitstream (S1522). As a method of decoding the geometric image, a decoding method corresponding to a geometric image encoding method used in the mesh encoding apparatus may be used.

The mesh decoding apparatus decodes an occupancy image from the fifth bitstream (S1524). When a common compression method is used, the mesh decoding apparatus may generate a binary map.

The mesh decoding apparatus entropy-decodes the sixth bitstream to reconstruct patch information (S1526).

The mesh decoding apparatus decodes a texture image from the fourth bitstream (S1528). As a method of decoding the texture image (i.e., texture map), a decoding method corresponding to the texture image encoding method used in the mesh encoding apparatus may be used.

The mesh decoding apparatus reconstructs three-dimensional geometric information of the patches by using the geometric image and the occupancy image (S1530).

The mesh decoding apparatus synthesizes patches by using the geometric information and the patch information (S1532). In this case, the points of the patches may represent vertices, i.e., vertex data.

The mesh decoding apparatus decodes edge data from the second bitstream (S1504). As an edge data reconstruction method, a decoding method corresponding to an edge data encoding method used in the mesh encoding apparatus may be used.

The mesh decoding apparatus synthesizes a three-dimensional mesh by using vertex data, edge data, and a texture map (S1506).

The following describes an encoding method performed by the mesh encoding apparatus utilizing the reconstructed vertex information, illustrated in FIG. 11.

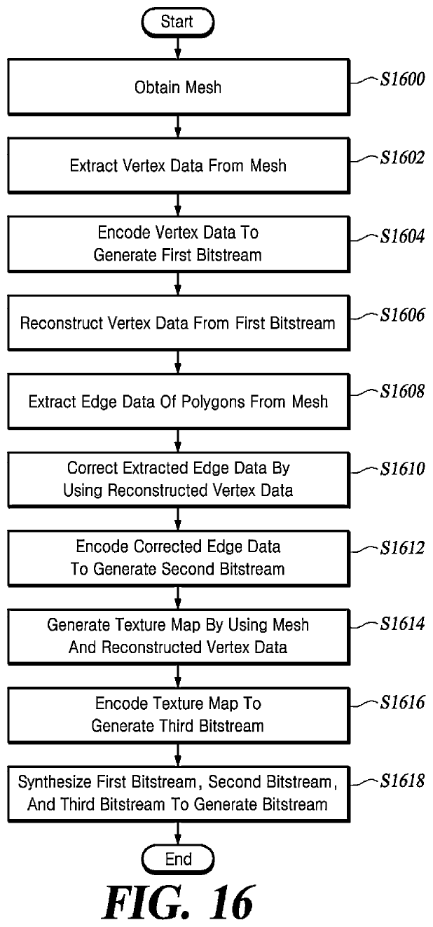

FIG. 16 is a flowchart of a mesh encoding method according to yet another embodiment of the present disclosure.

The mesh encoding apparatus obtains a mesh (S1600).

The mesh encoding apparatus extracts vertex data from the mesh (S1602). The mesh encoding apparatus may extract such data as ASCII expressions of vertices, texture vertices, normal vectors of vertices, and the like from the mesh information.

The mesh encoding apparatus encodes the vertex data to generate a first bitstream (S1604). As described above, the mesh encoding apparatus may utilize a conventional lossless data compression method to encode the vertex information.

The mesh encoding apparatus reconstructs the vertex data from the first bitstream (S1606).

The mesh encoding apparatus extracts edge data of polygons from the mesh (S1608) and then corrects the extracted edge data by using the reconstructed vertex data (S1610). The edge data may be an ASCII expression of data.

The mesh encoding apparatus encodes the corrected edge data to generate a second bitstream (S1612). The mesh encoding apparatus may utilize the reconstructed vertex data when encoding the edge data. The mesh encoding apparatus may generate the bitstream by using a common data compression method. Alternatively, the mesh encoding apparatus may utilize a common lossless compression method to generate the bitstream.

The mesh encoding apparatus generates a texture map by using the mesh and reconstructed vertex data (S1614). Using the original mesh and the reconstructed vertex data, the mesh encoding apparatus may generate a two-dimensional texture map by orthogonally projecting the textures of planes of the three-dimensional object into the uv domain.

The mesh encoding apparatus encodes the texture map to generate a third bitstream (S1616). The mesh encoding apparatus may encode the texture map by using image compression methods or video compression techniques, as described above.

The mesh encoding apparatus synthesizes the first bitstream, the second bitstream, and the third bitstream to generate a bitstream (S1618). The mesh encoding apparatus may store the generated bitstream or transmit it to the mesh decoding apparatus.

As described above, as a reconstruction apparatus corresponding to the mesh encoding apparatus illustrated in FIG. 11, the mesh decoding apparatus illustrated in FIG. 2B may be utilized. Hereinafter, a mesh decoding method as performed by the mesh decoding apparatus illustrated in FIG. 2B is described.

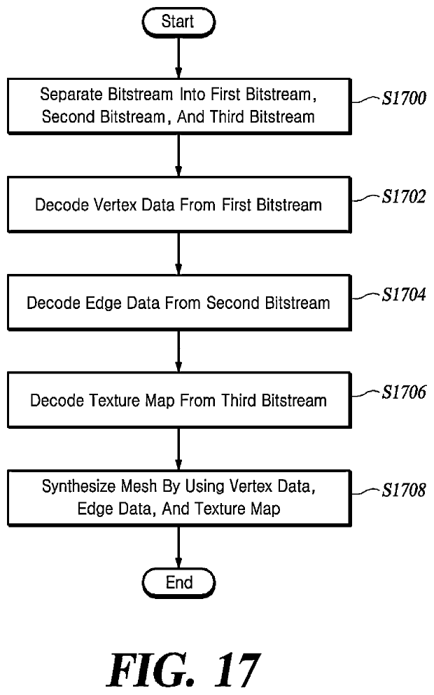

FIG. 17 is a flowchart of a mesh decoding method according to yet another embodiment of the present disclosure.

The mesh decoding apparatus separates a bitstream into a first bitstream, a second bitstream, and a third bitstream (S1700).

The mesh decoding apparatus decodes vertex data from the first bitstream (S1702).

The mesh decoding apparatus decodes edge data from the second bitstream (S1704). As an edge data reconstruction method, a decoding method corresponding to an edge data encoding method used in the mesh encoding apparatus may be used.

The mesh decoding apparatus decodes a texture map from the third bitstream (S1706). As a texture map reconstruction method, a decoding method corresponding to a texture map encoding method used in the edge encoding apparatus may be used.

The mesh decoding apparatus synthesizes a mesh by using the vertex data, the edge data, and the texture map (S1708).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

(Reference Numerals)

| | |
|---|---|
| 206: edge extractor | 208: edge encoder |
| 228: edge decoder | 234: mesh synthesizer |
| 302: point cloud transformer | 304: point cloud encoder |
| 324: point cloud decoder | |

What is claimed is:

1. A decoding method performed by a mesh decoding apparatus for decoding a mesh that is three-dimensional, the decoding method comprising:
separating a bitstream into a first bitstream and a second bitstream, the first bitstream being obtained by encoding a point cloud representative of the mesh, and the second bitstream being obtained by encoding edge data of the mesh;
decoding the point cloud from the first bitstream;
decoding the edge data from the second bitstream; and
synthesizing the mesh by generating planes of polygons using the edge data and by generating a texture of the planes using attribute values of the point cloud, which are closest to the planes.

2. The decoding method of claim 1, wherein separating the bitstream comprises:
separating the first bitstream into a third bitstream, a fourth bitstream, a fifth bitstream, and a sixth bitstream.

3. The decoding method of claim 2, wherein decoding the point cloud further comprises:
decoding a geometric image from the third bitstream;
decoding a texture image from the fourth bitstream;
decoding an occupation image from the fifth bitstream; and
reconstructing patch information by entropy-decoding the sixth bitstream.

4. The decoding method of claim 3, wherein decoding the point cloud further comprises:
reconstructing three-dimensional geometric information of patches by using the geometric image and the occupancy image; and
reconstructing attribute information of the patches by using the occupancy image and the texture image.

5. The decoding method of claim 4, wherein decoding the point cloud further comprises:
reconstructing the point cloud by synthesizing the patches using the geometric information, the attribute information, and the patch information.

6. An encoding method performed by a mesh encoding apparatus for encoding a mesh that is three-dimensional, the encoding method comprising:
obtaining the mesh;
extracting edge data of polygons from the mesh;
extracting vertices from the mesh and generating a texture map, and then transforming the mesh into a point cloud by using the vertices, the edge data, and the texture map;
generating a first bitstream by encoding the point cloud;
generating a second bitstream by encoding the edge data; and
synthesizing the first bitstream and the second bitstream to generate a bitstream.

7. The encoding method of claim 6, wherein transforming into the point cloud comprises:
extracting vertices from the mesh;
generating geometric information of the point cloud by generating planes of the polygons using the vertices and the edge data, and then sampling locations of points on the planes.

8. The encoding method of claim 6, wherein transforming into the point cloud further comprises:
generating a texture map by performing an orthogonal projection of texture information of the mesh into a two-dimensional domain;
generating texture map data including the texture map and information utilized in the orthogonal projection; and
generating attribute information of the point cloud by using the geometric information and the texture map data.

9. The encoding method of claim 6, wherein generating the first bitstream comprises:
generating patches by categorizing the point cloud into a plurality of groups; and
moving and rotating the patches to map the patches into a two-dimensional domain, and generating patch information,
wherein the patch information includes parameters for mapping the patches into the two-dimensional domain, a location at which the patches are mapped, and a size of each of the patches in the two-dimensional domain.

10. The encoding method of claim 9, wherein generating the first bitstream further comprises:
generating geometric images by using the patches, wherein the geometric images are a map representing depths between points in the patches and a two-dimensional plane when the patches are orthogonally projected to the two-dimensional plane;
applying padding to empty spaces in the geometric images where the depth is not defined; and
encoding the geometric images based on a video compression technique to generate a third bitstream.

11. The encoding method of claim 10, wherein generating the first bitstream further comprises:
generating a texture image by using the patches, wherein the texture image is an image generated by mapping attribute values of points to locations into which the points are projected on a plane when the points in the patches are orthogonally projected to the plane;
applying padding to portions of the texture image that are not occupied by the points; and
encoding the texture image based on a video compression technique to generate a fourth bitstream.

12. The encoding method of claim 11, wherein generating the first bitstream further comprises:
generating an occupancy image by using the patches, wherein the occupancy image is a binary map representing occupancy or inoccupancy by the points in the patches in a region on a plane when the patches are orthogonally projected to the plane; and
encoding the occupation image to generate a fifth bitstream.

13. The encoding method of claim 12, wherein generating the first bitstream further comprises:
entropy-encoding the patch information to generate a sixth bitstream.

14. The encoding method of claim 13, wherein generating the first bitstream further comprises:
generating the first bitstream by combining the third bitstream, the fourth bitstream, the fifth bitstream, and the sixth bitstream.

15. A computer-readable recording medium storing a bitstream generated by an encoding method for encoding a mesh that is three-dimensional, the encoding method comprising:
obtaining the mesh;
extracting edge data of polygons from the mesh;
extracting vertices from the mesh and generating a texture map, and then transforming the mesh into a point cloud by using the vertices, the edge data, and the texture map;
generating a first bitstream by encoding the point cloud;
generating a second bitstream by encoding the edge data; and
synthesizing the first bitstream and the second bitstream to generate a bitstream.
